(19) United States
(12) Patent Application Publication
(10) Pub. No.: US 2026/0148514 A1
(43) Pub. Date: May 28, 2026

(54) Devices and Methods Utilizing Machine Learning to Detect and Decode a Label

(71) Applicant: Zebra Technologies Corporation, Lincolnshire, IL (US)

(72) Inventors: Jason M. Gang, Plainview, NY (US); Richard Mark Clayton, Manorville, NY (US); Paul Seiter, Port Jefferson Station, NY (US)

(21) Appl. No.: 18/958,077

(22) Filed: Nov. 25, 2024

(51) Int. Cl. G06V 10/10; G06K 7/14; G06T 7/536; G06T 7/571; G06V 10/25; G06V 10/70; G06V 30/10; H04N 23/67

(52) U.S. Cl. CPC G06V 10/10; G06K 7/1413; G06T 7/536; G06T 7/571; G06V 10/25; G06V 10/70; G06V 30/10; H04N 23/67; G06T 2207/20081

(57) ABSTRACT

Devices and methods for detecting and decoding a label are disclosed herein. The method captures, by a device utilizing a current focus setting, a current image of an area having one or more labels present therein. The method determines a first distance between the device and one or more labels present in the current image based on the current focus setting during capture of the current image. The method detects, utilizing a trained model, the one or more labels present in the current image and determines, for a current label among the one or more labels, a second distance between the device and the current label based on a known size of the current label and/or a feature of the current label. The method determines whether the current label is in focus based on the first distance, the second distance, and at least one attribute of the device.

### BACKGROUND

A facility (e.g., a grocery store, a convenience store, a retail store, etc.) can include at least one support structure (e.g., a display module) with one or more support surfaces (e.g., shelves) for carrying and displaying one or more objects (e.g., products). For example, objects can be faced on a display module such that the objects are positioned on a front edge of a support surface of the display module and oriented to be identifiable (e.g., an associate or customer can observe an object associated and aligned with a label of a support surface such as a Stock Keeping Unit (SKU) or a product code). An associate of a facility can utilize a device (e.g., a smart phone, a tablet, a mobile computer, a head-mounted display, a scanner, a wearable computing device or the like) to identify each object displayed on a display module. For example, an associate can process a label (e.g., scan a SKU or a product code) associated with each object. Additionally, based on the identification, an associate can perform other tasks including, but not limited to, locating, picking, and/or re-stocking each object displayed on a display module.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of a system of the present disclosure.

FIGS. 2A-C are diagrams illustrating another embodiment of a system of the present disclosure.

FIG. 3 is a diagram illustrating components of the computing device of FIG. 1 and FIG. 2C.

FIG. 4 is a flowchart illustrating processing steps carried out by an embodiment of the present disclosure.

FIG. 5A-B are diagrams illustrating labels of an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

As mentioned above, an associate of a facility can utilize a device (e.g., a smart phone, a tablet, a mobile computer, a head-mounted display, a scanner, a wearable computing device or the like) to identify each object displayed on a display module. For example, an associate can process a label (e.g., scan a SKU or a product code) associated with each object. Additionally, based on the identification, an associate can perform other tasks including, but not limited to, locating, picking, and/or re-stocking each object displayed on a display module.

Scanning a label associated with each object is a manual process (e.g., relies on human intervention) and, as such, can be time-consuming, cost-prohibitive (e.g., increased associate labor costs), and subject to human error (e.g., scanning an incorrect label). For example, a display module can have hundreds, if not thousands, of labels affixed thereto such that it can be time-consuming and cost-prohibitive to manually process each label (e.g., scan a SKU or a product code) associated with each object to identify each object, locate each object, pick each object and/or determine whether each object requires re-stocking.

Conventional imaging systems for processing a label may capture an image of a label and/or associated object and process the label present in the image. However, these systems can be cost-prohibitive to deploy and utilize in a facility and/or provide underwhelming performance and reduce the efficiency and general timeliness of label processing. For example, high-resolution imaging systems are cost-prohibitive to deploy and utilize in a facility because these systems require one or more high-resolution cameras to capture an image of sufficient quality (e.g., sufficient resolution) to detect and identify (e.g., recognize and/or decode) one or more labels present in the image that are positioned at varying distances from the cameras.

In another example, low-resolution imaging systems utilize one or more low-resolution cameras. However, low-resolution cameras generally capture an image of insufficient quality (e.g., insufficient resolution) to detect and identify (e.g., recognize and/or decode) one or more labels present in the image that are positioned at varying distances from the cameras. For example, low-resolution cameras can capture images having one or more labels present therein that are out of focus and illegible (e.g., one or more identifiers of a label cannot be recognized and/or decoded). Additionally, these low-resolution imaging systems may nevertheless attempt to recognize and/or decode illegible labels which consumes substantial amounts of power and processing resources without providing a benefit.

Proposed techniques to mitigate deficiencies with low-resolution imaging systems include utilizing different focus settings (e.g., autofocus, fixed focus, and multiple focus) of one or more low-resolution cameras to capture an image of sufficient quality to detect and identify (e.g., recognize and/or decode) one or more labels present in the image that are positioned at varying distances from the cameras. However, these proposed techniques can also yield labels that are out of focus and illegible and systems utilizing the proposed techniques may nevertheless attempt to recognize and/or decode illegible labels. For example, an autofocus setting may focus on an object and associated label within a center of a field of view (FOV) of a low-resolution camera which renders one or more labels positioned outside of the center of the FOV out of focus and illegible. In another example, cycling through multiple focus settings of a low-resolution camera provides for mismatching a respective cycled focus setting with one or more labels positioned at varying distances from the low-resolution camera which renders the one or more labels out of focus and illegible. As noted above, low-resolution imaging systems utilizing the proposed techniques may nevertheless attempt to recognize and/or decode illegible labels which consumes substantial amounts of power and processing resources without providing a benefit.

Additionally, the volume of images and plurality of labels present in each image often results in redundant illegible labels which reduces a processing efficiency of an imaging device and/or system and an efficiency of the detection and identification (e.g., recognition and/or decoding) process of the labels present in each image.

As such, conventional systems suffer from a general lack of versatility because these systems cannot automatically and dynamically determine whether a label is in focus and process the label when the label is in focus or modify a focus setting of a device when the label is not in focus. For example, these systems cannot automatically and dynamically determine whether a label present in an image captured by a device is in focus according to a first distance between the device and the label based on a current focus setting of the device, a second distance between the device and the label based on a known size of the label and/or a feature of the label, and at least one attribute of the device. Additionally, these systems cannot automatically and dynamically determine another focus setting of a device based on at least the second distance of the label when the label is not focus.

Overall, this lack of versatility causes conventional systems to provide underwhelming performance and reduce the efficiency and general timeliness of label processing. Thus, it is an objective of the present disclosure to eliminate these and other problems with conventional systems and methods via systems and methods that can detect a label, determine whether a label is in focus and process the label when the label is in focus or modify a focus setting of a device when the label is not in focus.

In accordance with the above, and with the disclosure herein, the present disclosure includes improvements in computer functionality or improvements to other technologies at least because the present disclosure describes that, e.g., image processing devices and/or systems, and their related various components, may be improved or enhanced with the disclosed dynamic system features and methods that automatically and dynamically detect a label, determine whether a label is in focus and process the label when the label is in focus or modify a focus setting of a device when the label is not in focus.

That is, the present disclosure describes improvements in the functioning of an imaging device and/or image processing device and/or system and/or “any other technology or technical field” (e.g., the field of image processing). For example, the disclosed dynamic system features and methods improve and enhance the detection and identification of a label by introducing the automatic and dynamic determination of whether a label is in focus and processing the label when the label is in focus or modifying a focus setting of a device when the label is not in focus to mitigate (if not eliminate) worker error and eliminate inefficiencies typically experienced over time by systems lacking such features and methods. This improves the state of the art at least because such previous systems are inefficient as they lack the ability to automatically and dynamically determine whether a label is in focus and process the label when the label is in focus or modify a focus setting of a device when the label is not in focus.

In addition, the present disclosure applies various features and functionality, as described herein, with, or by use of, a particular machine, e.g., a processor, a device, and/or other hardware components as described herein. Moreover, the present disclosure includes specific features other than what is well-understood, routine, conventional activity in the field, or adding unconventional steps that demonstrate, in various embodiments, particular useful applications, e.g., image processing protocols of a device for automatically and dynamically determining whether a label is in focus and processing the label when the label is in focus or modifying a focus setting of a device when the label is not in focus.

Accordingly, it would be highly beneficial to develop a system and method that can automatically and dynamically detect a label, determine whether the label is in focus, and process the label when the label is in focus or modify a focus setting of a device when the label is not in focus. The systems and methods of the present disclosure address these and other needs.

In an embodiment, the present disclosure is directed to a method. The method comprises: capturing, by a device utilizing a current focus setting, a current image of an area where the area has one or more labels present therein; determining a first distance between the device and one or more labels present in the current image based on the current focus setting of the device during capture of the current image; detecting, utilizing a trained machine learning model, the one or more labels present in the current image where each label has one or more identifiers; determining whether the one or more labels are assessed; responsive to determining the one or more labels are not assessed, determining, for a current label among the one or more labels, a second distance between the device and the current label based on a known size of the current label and/or a feature of the current label; determining whether the current label is in focus based on the first distance, the second distance of the current label, and at least one attribute of the device; and responsive to determining the current label is in focus, processing the current label.

In an embodiment, the present disclosure is directed to a device comprising an imaging assembly; one or more processors; and a non-transitory computer-readable memory coupled to the one or more processors. The memory stores instructions thereon that, when executed by the one or more processors, cause the one or more processors to: receive a current image, captured by the imaging assembly utilizing a current focus setting, of an area, the area having one or more labels present therein; determine a first distance between the device and one or more labels present in the current image based on the current focus setting of the imaging assembly during capture of the current image; detect, utilizing a trained machine learning model, the one or more labels present in the current image, each label having one or more identifiers; determine whether the one or more labels are assessed; responsive to determining the one or more labels are not assessed, determine, for a current label among the one or more labels, a second distance between the device and the current label based on a known size of the current label and/or a feature of the current label; determine whether the current label is in focus based on the first distance, the second distance of the current label, and at least one attribute of the imaging assembly; and responsive to determining the current label is in focus, process the current label.

In an embodiment, the present disclosure is directed to a non-transitory computer-readable medium. The non-transitory computer-readable medium stores instructions thereon that, when executed by one or more processors, cause the one or more processors to: receive a current image, captured by an imaging assembly utilizing a current focus setting, of area where the area has one or more labels present therein; determine a first distance between the device and one or more labels present in the current image based on the current focus setting of the imaging assembly during capture of the current image; detect, utilizing a trained machine learning model, the one or more labels present in the current image, each label having one or more identifiers; determine whether the one or more labels are assessed; responsive to determining the one or more labels are not assessed, determine, for a current label among the one or more labels, a second distance between the device and the current label based on a known size of the current label and/or feature of the current label; determine whether the current label is in focus based on the first distance, the second distance of the current label, and at least one attribute of the imaging assembly; and responsive to determining the current label is in focus, process the current label.

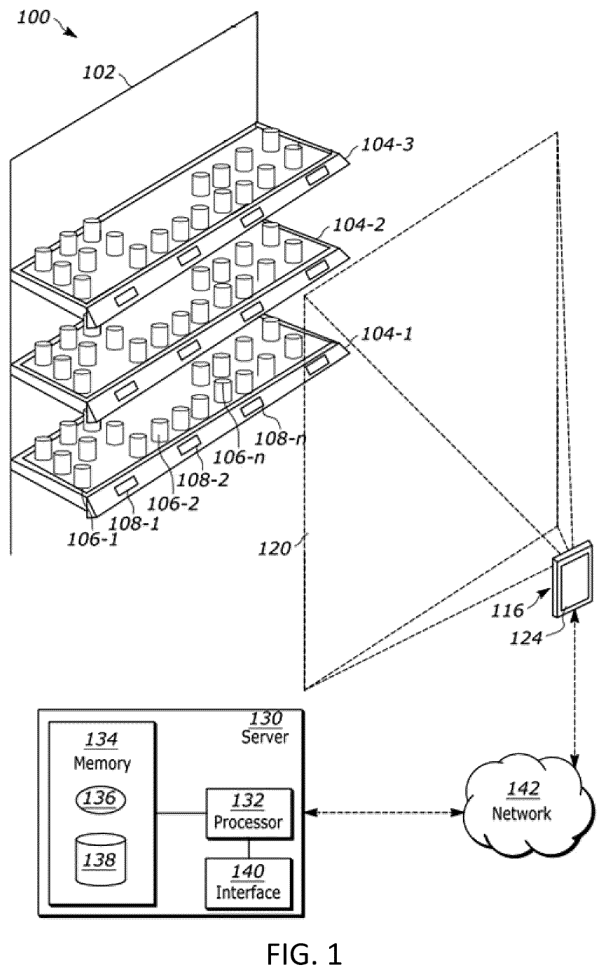

Turning to the Drawings, FIG. 1 is a diagram 100 illustrating an embodiment of a system of the present disclosure. The system may be deployed in a facility (e.g., a grocery store, a convenience store, a retail store, etc.). For example, the system may be deployed in an associate-accessible portion of the facility that may be referred to as the back of the facility (e.g., a storage room, a stock room, an inventory room, etc.) and/or a customer-accessible portion of the facility that may be referred to as the front of the facility. Objects received at the facility, e.g. via a receiving bay or the like, are generally placed on a support structure (e.g., a display module) with one or more support surfaces (e.g., shelves) in a back room, until restocking of the relevant objects is required in the front of the facility. An associate can retrieve the objects requiring restocking from the back room, and transport those objects to the appropriate locations in the front of the facility.

As shown in FIG. 1, the facility includes at least one support structure such as a display module 102 with one or more support surfaces 104-1, 104-2, and 104-3 (collectively referred to as support surfaces 104, and generically referred to as support surface 104) carrying and displaying objects 106-1, 106-2, and 106-n (collectively referred to as objects 106, and generically referred to as object 106). The objects 106 may be of different types such that object 106-1 is different from objects 106-2 and 106-n, object 106-2 is different from object 106-n, etc. In addition, an object 106 can be grouped with one or more objects. For example, object 106-1 is grouped with eight objects 106-1 and object 106-2 is grouped with three objects 106-2. Objects 106-1, 106-2 and 106-3 can be respectively identified by object labels 108-1, 108-2 and 108-n (collectively referred to as labels 108, and generically referred to as label 108). A label 108 may include one or more identifiers (e.g., a barcode, a numeric character string, an alpha character string, and an alphanumeric character string). For example, the label 108 may include a SKU and/or product code (e.g. a Universal Product Code (UPC)) or the like.

The system can include a computing device 116 (e.g., a smart phone, a tablet, a mobile computer, a head-mounted display, a scanner, or a wearable computing device or the like). The computing device 116 can be operated by an associate at the facility, and includes at least an imaging assembly (e.g., a camera) having a field of view (FOV) 120 and a display 124. Alternatively, the computing device 116 can be an imaging assembly (e.g., a camera). For example, the computing device 116 can be a camera mounted on a first display module 102 and having a FOV 120 of at least a portion of a second display module 102 positioned across therefrom. In another example, the computing device 116 can be a camera fixed in an overhead position above a display module 102 and having a FOV 120 of at least a portion of a display module 102 positioned beneath the computing device 116. The computing device 116 can be manipulated such that an imaging assembly thereof can view at least a portion of the display module 102 within the FOV 120 and can be configured to capture an image or a stream of images of the display module 102. From such images, the computing device 116 can detect and identify (e.g., recognize and/or decode) a label 108 associated with an object 106. The computing device 116 can also generate and/or update a log associated with the display module 102 based on the identified labels 108 where the log is indicative of an inventory of objects 106 positioned on the display module 102. The computing device 116 can exchange data with the server 130, e.g., via a network 142 implemented as any suitable combination of local and wide-area networks.

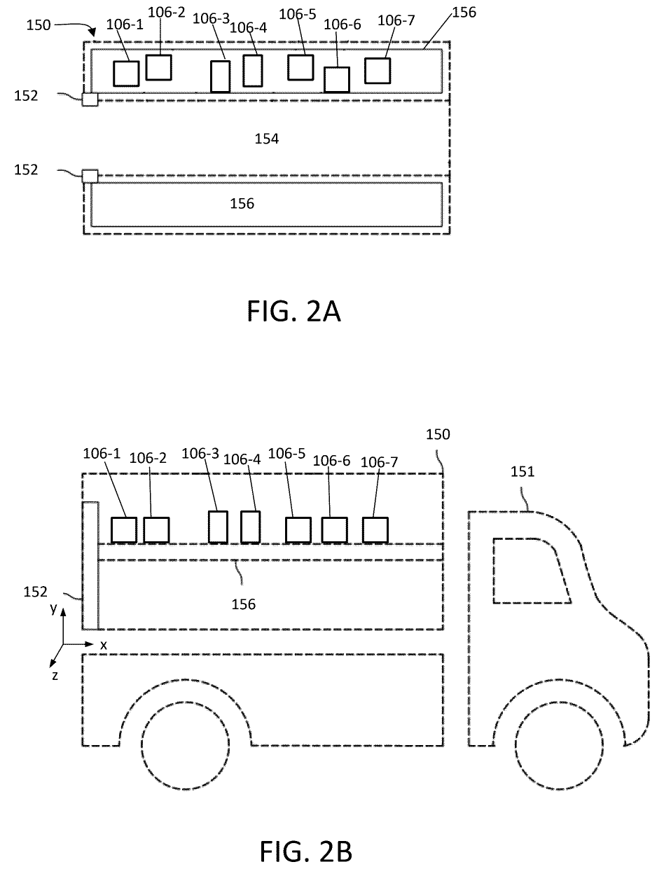

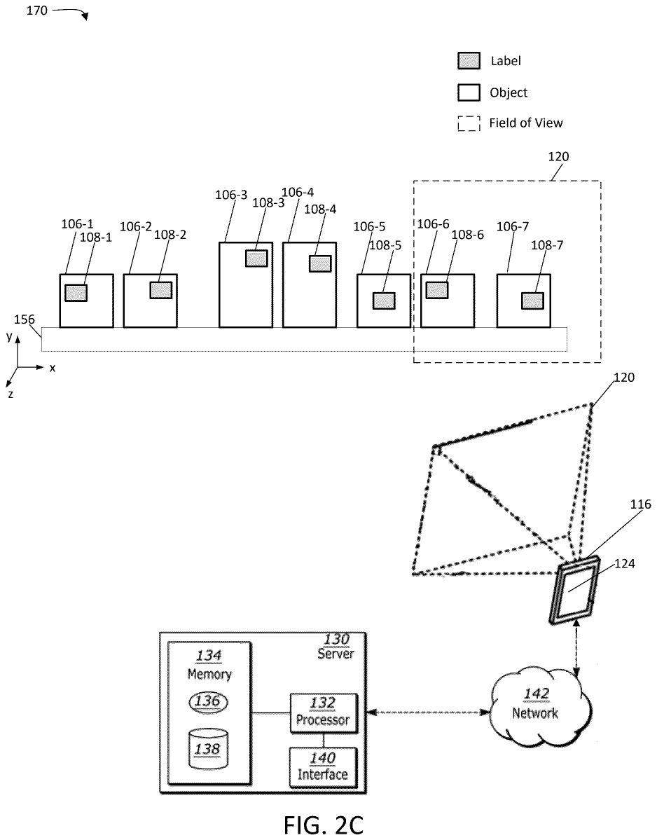

It should be understood that the system may also be deployed in any suitable environment. For example, the system may also be deployed in a logistics environment as described in further detail below in relation to FIGS. 2A-C.

The server 130 can include a processor 132 (e.g. one or more central processing units (CPUs)), interconnected with a non-transitory computer readable storage medium, such as a memory 134 and an interface 140. The memory 134 includes a combination of volatile memory (e.g. Random Access Memory or RAM) and non-volatile memory (e.g. read only memory or ROM, Electrically Erasable Programmable Read Only Memory or EEPROM, or flash memory). The processor 132 and the memory 134 each comprise one or more integrated circuits.

The memory 134 stores computer readable instructions for execution by the processor 132. The memory 134 stores an image processing application 136 (also referred to simply as the application 136) which, when executed by the processor 132, configures the processor 132 to perform various functions described below in greater detail and related to automatically and dynamically detecting a label 108, determining whether a label 108 is in focus, and processing the label 108 when the label 108 is in focus or modifying a focus setting of a computing device 116 when the label 108 is not in focus. For example, the application 136, when executed by the processor 132, configures the processor 132 to: receive a current image, captured by an imaging assembly (not shown) of a computing device 116 utilizing a current focus setting, of an area where the area has one or more labels 108 present therein; determine a first distance between the device and one or more labels 108 present in the current image based on the current focus setting of the imaging assembly during capture of the current image; detect, utilizing a trained machine learning model, the one or more labels 108 present in the current image where each label 108 has one or more identifiers; determine whether the one or more labels 108 are assessed; responsive to determining the one or more labels are not assessed, determine, for a current label among the one or more labels, a second distance between the device 116 and the current label 108 based on a known size of the current label 108 and/or a feature of the current label 108; determine whether the current label 108 is in focus based on the first distance, the second distance of the current label 108, and at least one attribute of the imaging assembly; and responsive to determining the current label 108 is in focus, process the current label 108. As described below, this functionality can also be executed by the processor 202 of the device 116.

The application 136 may also be implemented as a suite of distinct applications in other examples. Those skilled in the art will appreciate that the functionality implemented by the processor 132 via the execution of the application 136 may also be implemented by one or more specially designed hardware and firmware components, such as field-programmable gate arrays (FPGAs), application-specific integrated circuits (ASICs) and the like in other embodiments.

The memory 134 also stores a database 138. The database 138 may store one or more image datasets of a plurality of labels 108 (e.g., for training a machine learning model to detect, classify, and/or decode a label 108 and one or more identifiers thereof). The database 138 may also store one or more captured images (e.g., historical data) of previously detected labels 108 where the images can be utilized to train the machine learning model to detect a label 108 based on the distinctive features (e.g., size, shape, color, or the like) thereof. It should be understood that the database 138 may be stored in a memory (not shown) of the computing device 116.

The server 130 also includes a communications interface 140 enabling the server 130 to communicate with other computing devices, including the computing device 116, via the network 142. The communications interface 140 includes suitable hardware elements (e.g. transceivers, ports and the like) and corresponding firmware according to the communications technology employed by the network 142.

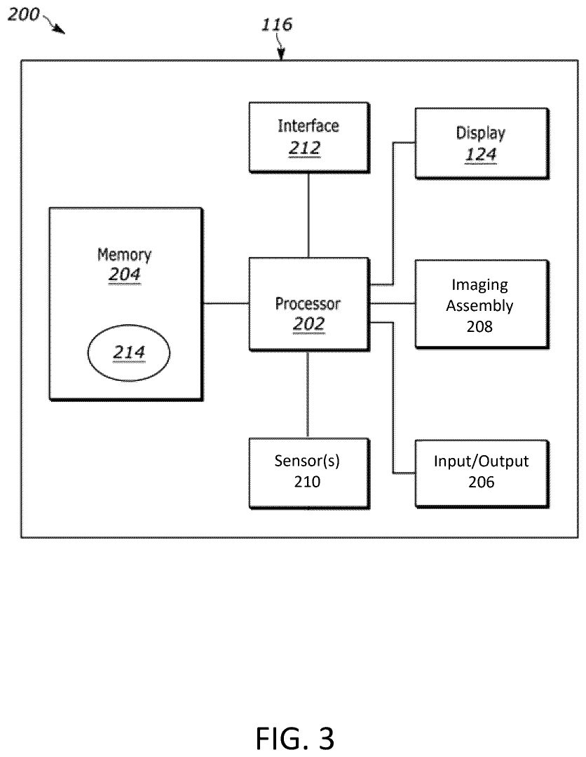

FIG. 3 is a diagram 200 illustrating components of the computing device 116 of FIG. 1 and FIG. 2C. As mentioned above, the computing device 116 may be, but is not limited to, a smart phone, a tablet, a mobile computer, a head-mounted display, a scanner, a wearable computing device, or the like. The computing device 116 can be operated by an associate at the facility, and includes at least an imaging assembly 208 (e.g., a camera) having a FOV 120 and a display 124. Alternatively, the computing device 116 can be an imaging assembly 208 (e.g., a camera). The computing device 116 may capture an image or stream of images of an object 106 and associated label 108. As shown in FIG. 2, the computing device 116 includes a processor 202, a memory 204, a display 124, an input/output 206, an imaging assembly 208, sensor(s) 210, and an interface 212.

The processor 202 may be one or more CPUs, a graphics processing unit (GPU), or a combination thereof and is communicatively coupled with a memory 204 (e.g., a non-transitory computer-readable storage medium implemented as a suitable combination of volatile and non-volatile memory elements), a display 124, an input/output 206, an imaging assembly 208, sensor(s) 210, and an interface 212. The processor 202 and the memory 204 each comprise one or more integrated circuits.

The memory 204 can store a plurality of computer-readable instructions, e.g., in the form of an image processing application 214 (also referred to simply as the application 214) which, when executed by the processor 202, configures the processor 202 to perform various functions described below in greater detail and related to automatically and dynamically detecting a label 108, determining whether a label 108 is in focus, and processing the label 108 when the label 108 is in focus or modifying a focus setting of a computing device 116 when the label 108 is not in focus. For example, the application 214, when executed by the processor 202, configures the processor 202 to: receive a current image, captured by an imaging assembly (not shown) of a computing device 116 utilizing a current focus setting, of an area where the area has one or more labels 108 present therein; determine a first distance between the device and one or more labels 108 present in the current image based on the current focus setting of the imaging assembly during capture of the current image; detect, utilizing a trained machine learning model, the one or more labels 108 present in the current image where each label 108 has one or more identifiers; determine whether the one or more labels 108 are assessed; responsive to determining the one or more labels are not assessed, determine, for a current label among the one or more labels, a second distance between the device 116 and the current label 108 based on a known size of the current label 108 and/or a feature of the current label 108; determine whether the current label 108 is in focus based on the first distance, the second distance of the current label 108, and at least one attribute of the imaging assembly; and responsive to determining the current label 108 is in focus, process the current label 108.

The application 214 may also be implemented as a suite of distinct applications in other examples. Those skilled in the art will appreciate that the functionality implemented by the processor 202 via the execution of the application 214 may also be implemented by one or more specially designed hardware and firmware components, such as FPGAs, ASICs, and the like in other embodiments. As noted above, in some examples the memory 204 can also store the database 138, rather than the database 138 being stored at the server 130.

The display 124 may be any suitable display including, but not limited to, a light emitting diode (LED) display, an organic LED display, a liquid crystal display (LCD), and a touchscreen display.

The imaging assembly 208 (e.g., a camera) may include a suitable sensor (e.g., an accelerometer, a gyroscope, a magnetometer, an altimeter, or a proximity sensor) or combination of sensors. Alternatively, the imaging assembly 208 and the sensor(s) 210 may be independent of one another. In another alternative, the device 116 may be an imaging assembly 208 (e.g., a camera) having a FOV and one or more sensors 210 integrated therein or coupled thereto.

The input/output 206 can be a device interconnected with the processor 202. The input device 206 is configured to receive an input (e.g. from a user of the device 116) and provide data representative of the received input to the processor 202. The input device 206 can include any one of, or a suitable combination of, a touch screen integrated with the display 124, a keypad, a microphone, and the like. In addition to the display 124, the device 116 can also include an output 206. The output 206 can be a device interconnected with the processor 202. The output device 206 is configured to receive an output (e.g., a signal from a processor 202) and provide an indication representative of the received output. The output device 206 can include any one of, or a suitable combination of a speaker, a headset, a notification LED, and the like.

The communications interface 212 enables communication between the device 116 and other computing devices (e.g., a server 130), via suitable short-range links, networks such as the network 142, and the like. The interface 212 therefore includes suitable hardware elements, executing suitable software and/or firmware, to communicate over the network 142 and/or other communication links.

The sensor(s) 210 can include any one of, or any suitable combination of, sensors configured to facilitate determining a focus setting of the imaging assembly 208 and/or a distance between the device 116 and a label 108 during image capture. For example, the sensor(s) 214 can comprise an inertial navigation system including one or more of an accelerometer, a gyroscope, a magnetometer, an altimeter, or a proximity sensor. In this way, the sensor(s) 214 in conjunction with one or more other components (e.g., the imaging assembly 208) of the device 116 provide for spatial computing (e.g., ARCore by Google) to determine a position and orientation of a device 116 utilized by a user.

FIGS. 2A-C are diagrams illustrating another embodiment of a system of the present disclosure. In an embodiment, the system may be deployed in a logistics environment. In logistics operations, a wide variety of objects 106, such as packages and other freight, can be transported in a container 150 implemented as a storage unit affixed to or stored in a vehicle 151 from origin locations to destination locations. Each object 106 may have a respective label 108 affixed thereto to identify the object 106 and facilitate the transportation thereof. A label 108 may include one or more identifiers (e.g., a barcode, a numeric character string, an alpha character string, and an alphanumeric character string). An operator of the vehicle 151 may utilize the computing device 116 to capture an image or a stream of images of an interior of the container 150. From such images, the computing device 116 can detect and identify (e.g., recognize and/or decode) a label 108 affixed to an object 106.

FIGS. 2A-B are diagrams illustrating a container 150. FIG. 2A is a diagram illustrating an overhead view of the container 150 and FIG. 2B is a diagram illustrating a side view of the container 150. As shown in FIGS. 2A and 2B, the container 150 is a storage unit affixed to a vehicle 151 (e.g., a box truck). In alternate embodiments, the container 150 may be one of a storage unit affixed to or stored in a vehicle 151 including a trailer affixed to a platform having one or more sets of wheels and a hitch assembly for towing by the vehicle, or a unit loading device (ULD) stored in an aircraft, or a storage area integrated in at least a portion of a vehicle 151 including a sports utility vehicle (SUV), a van, a cargo van, a commercial van, a sprinter van, or a step van. The container 150 may include a doorway 152, an aisle 154, at least one support structure such as a shelf 156 (two shelves 156 at approximately the same height are shown), onto which objects 106 can be positioned. As shown in FIGS. 2A and 2B, objects 106 are loaded into the container 150. Additionally, as shown in FIG. 2A, the objects 106 may be positioned at different depths on a shelf 156.

FIG. 2C is a diagram 170 illustrating image capture carried out by an embodiment of the present disclosure. As shown in FIG. 2C, the computing device 116 has a display 124 and an imaging assembly 208 (not shown) having a known FOV 120. The computing device 116 may capture an image or stream of images of one or more objects 106 within the FOV 120 of the imaging assembly 208 such that the image or stream of images may include one or more objects 106 and respective labels 108 thereof. As shown in FIG. 2C, a FOV 120 of the imaging assembly 208 (not shown) may capture an image or a stream of images including object 106-6 having a label 108-6 and object 106-7 having a label 108-7.

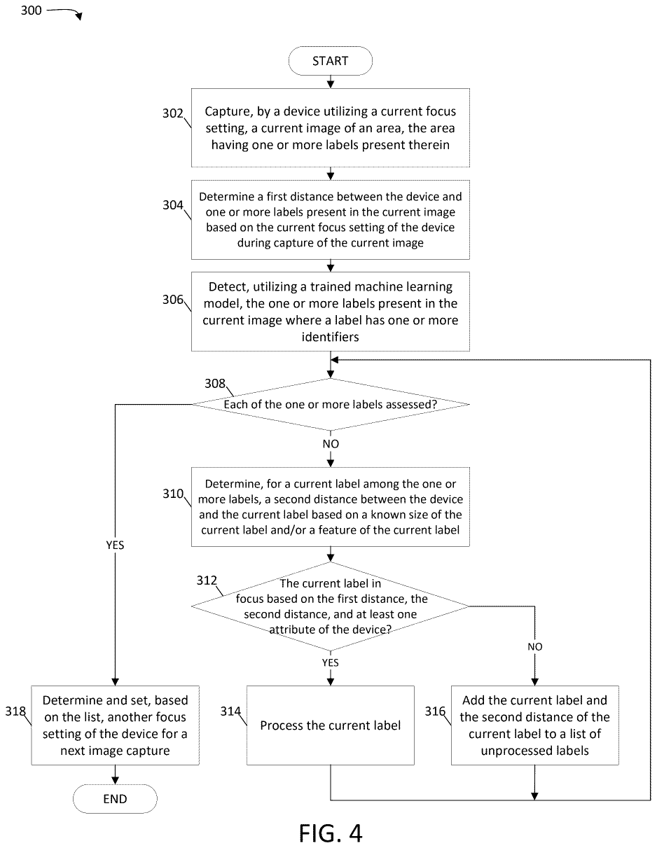

FIG. 4 is a flowchart illustrating processing steps carried out by an embodiment of the present disclosure. The processing steps will be described in conjunction with their performance in the system (e.g., by the device 116 or the server 130 in conjunction with the device 116). In general, via performance of the processing steps, the system can automatically and dynamically detect a label 108, determine whether the label 108 is in focus, and process the label 108 when the label 108 is in focus or modify a focus setting of a device 116 when the label 108 is not in focus.

For example, the system can receive, by a device utilizing a current focus setting, a current image of an area where the area has one or more labels present therein; determine, for the current image, a first distance between the device and the one or more labels based on the current focus setting of the device during capture of the current image; detect, utilizing a trained machine learning model, the one or more labels present in the current image where a label has one or more identifiers; determine whether the one or more labels are assessed; responsive to determining the one or more labels are assessed, determine, for a current label among the one or more labels, a second distance between the device and the current label based on a known size of the current label and/or a feature of the current label; determine whether the current label is in focus based on the first distance, the second distance, and at least one attribute of the device; and responsive to determining the current label is in focus, process the current label. Alternatively, responsive to determining the current label is not in focus, add the current label and the second distance of the current label to a list of unprocessed labels.

Referring to FIG. 4, in step 302, the system receives from a device 116 utilizing a current focus setting, a current image of an area (e.g., a display module 102, a container 150, or the like) where the area has one or more labels 108 present therein. For example, the device 116 may capture an image or stream of images of one or more objects 106 and associated labels 108 thereof within the FOV 120 of the device 116 or the FOV 120 of an imaging assembly 208 thereof where the objects 106 are positioned on a support surface 104 of a display module 102. In another example, the device 116 may capture an image or stream of images of one or more objects 106 and associated labels 108 thereof within the FOV 120 of the device 116 or the FOV 120 of an imaging assembly 208 thereof where the objects 106 are positioned on a support surface 156 of a container 150. The device 116 may include, but is not limited to, a smart phone, a tablet, a mobile computer, a head-mounted display, a scanner, or a wearable computing device. The current focus setting may be one of a fixed focus setting of the device 116 or of an imaging assembly 208 of the device 116 or an autofocus setting of the device 116 or of an imaging assembly 208 of the device 116.

In step 304, the system determines a first distance between the device 116 and one or more labels 108 present in the current image based on the current focus setting of the device 116 during capture of the current image. For example, the first distance may be a known distance between the device 116 and the one or more labels 108 based on the current focus setting of the device 116 or of an imaging assembly 208 of the device 116. As noted above, the device 116 can include sensor(s) 210 where the sensor(s) 214 can comprise an inertial navigation system including one or more of an accelerometer, a gyroscope, a magnetometer, an altimeter, or a proximity sensor. In this way, the sensor(s) 214 in conjunction with one or more other components (e.g., the imaging assembly 208) of the device 116 provide for spatial computing (e.g., ARCore by Google) to determine a position and orientation of a device 116 utilized by a user. Optionally, the system may utilize spatial computing to confirm and/or refine a determined first distance between the device 116 and the one or more labels 108. Additionally and as described below, the system may optionally utilize spatial computing to confirm and/or refine a determined second distance between the device 116 and a current label 108 among the one or more labels 108.

In step 306, the system detects, utilizing a trained machine learning model, the one or more labels 108 present in the current image where a label 108 has one or more identifiers. For example, the system can detect a current label 108 among the one or more labels 108 utilizing a trained machine learning model by generating a bounding box corresponding to the current label 108 and determining a pixel size of the current label 108 based on a pixel length and a pixel height of the bounding box. A size of a label 108 according to a bounding box thereof may change based on the first distance and/or an obliqueness of the view. As noted above, the database 138 may store one or more image datasets of a plurality of labels 108 for training the machine learning model to detect, classify, and/or decode a label 108 and one or more identifiers thereof. The database 138 may also store one or more captured images (e.g., historical data) of previously detected labels 108 where the images can be utilized to train the machine learning model to detect a label 108 based on the distinctive features (e.g., size, shape, color, or the like) thereof. As such, the system may train a machine learning model to detect one or more labels 108 based on at least one of image datasets including images of one or more label types where each label type has a known size among other known and/or distinctive features or historical data including one or more previously detected labels 108. The label 108 may include one or more identifiers (e.g., a barcode, a numeric character string, an alpha character string, and an alphanumeric character string). For example, the label 108 may include a SKU and/or product code (e.g. a UPC) or the like. Alternatively, the label 108 may be an image (e.g., an image of an object, a landscape, an individual or any suitable image).

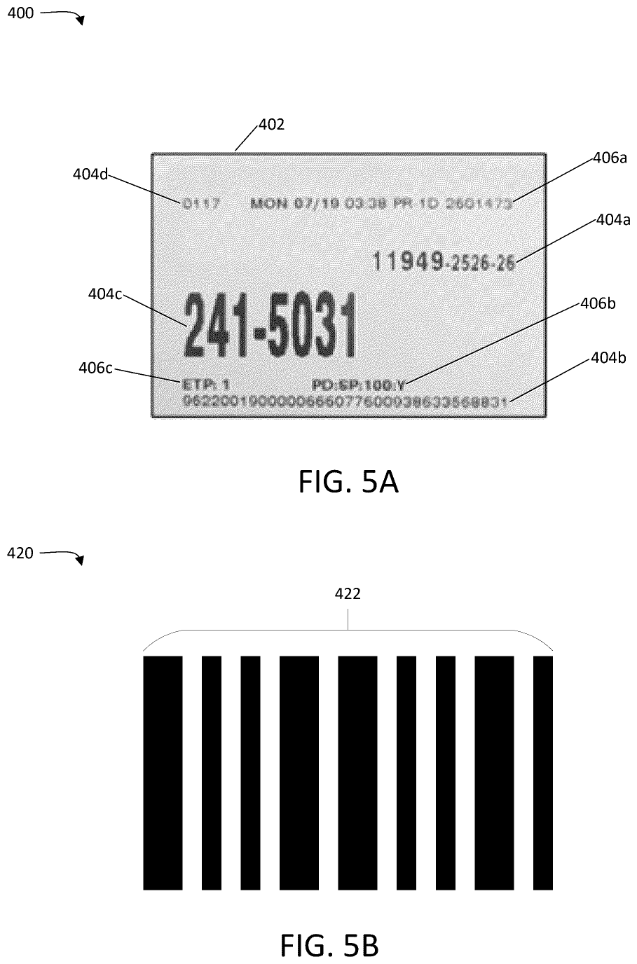

FIGS. 5A-B are diagrams illustrating labels of an embodiment of the present disclosure. FIG. 5A is a diagram 400 illustrating a label 402 having numeric character strings 404a, 404b, 404c, and 404d and alphanumeric character strings 406a, 406b, and 406c. FIG. 5B is a diagram 420 illustrating a label 422. The label 422 is a barcode comprised of parallel lines have varying widths, spacings and sizes. As described in further detail below, the system can process a label 108 associated with an object 106.

Referring back to FIG. 4, in step 308, the system determines whether each of the one or more labels 108 are assessed. If the system determines each of the one or more labels 108 are assessed, then the process proceeds to step 318 (described in further detail below). Alternatively, if the system determines each of the one or more labels 108 are not assessed, then the process proceeds to step 310. As described in further detail below, a portion of the processing steps 300 may repeat until each of the one or more labels 108 are assessed. For example, a portion of the processing steps 300 may repeat until each of the one or more labels 108 are processed in step 314, each of the one or more labels 108 and respective second distances are added to a list of unprocessed labels 108 in step 316, or a portion of the one or more labels 108 are processed in step 314 and the remaining portion of the one or more labels 108 and respective second distances are added to the list of unprocessed labels 108 in step 316.

In step 310, the system determines, for a current label 108 among the one or more labels 108, a second distance between the device 116 and the current label 108 based on a known size of the current label 108 and/or a feature of the current label 108. As noted above, a label 108 may have a type where each label type has a known size among other known and/or distinctive features (e.g., shape, color, or the like). Additionally, a label 108 may have a pixel size based on a pixel length and a pixel height of a bounding box corresponding to the label 108. As described above, the device 116 can include sensor(s) 210 where the sensor(s) 214 can comprise an inertial navigation system. In this way, the sensor(s) 214 in conjunction with one or more other components (e.g., the imaging assembly 208) of the device 116 provide for spatial computing (e.g., ARCore by Google) to determine a position and orientation of a device 116 utilized by a user. Optionally, the system may utilize spatial computing to confirm and/or refine a determined second distance between the device 116 and the current label 108.

In step 312, the system determines whether the current label 108 is in focus based on the first distance, the second distance of the current label 108, and at least one attribute of the device 116. The at least one attribute of the device 116 may be a depth of field of the device 116 (e.g., a camera) or a depth of field of an imaging assembly 208 of the device 116. If the system determines the current label 108 is in focus, then the process proceeds to step 314. Alternatively, if the system determines the current label 108 is not in focus, then the process proceeds to step 316.

In step 314, the system processes the current label 108. For example, the system may decode one or more identifiers of the current label 108 and select a decoded identifier or, if the current label 108 includes more than one identifier, select a decoded identifier corresponding to a predetermined symbology (e.g., including, but not limited to, a Universal Product Code (UPC), European Article Number (EAN), Code 128, Code39, and Data Matrix) and/or barcode data structure. In an embodiment, the system may need only to decode an initial identifier among the one or more identifiers if the initial identifier corresponds to the predetermined symbology and/or barcode data structure. In this way, the system can bypass processing of additional identifiers. In another example, the system may utilize character recognition to recognize one or more identifiers of the current label 108 and select a recognized identifier or, if the current label 108 includes more than one identifier, select a recognized identifier corresponding to a predetermined character string structure. The process then returns to step 308.

Referring back to step 312, if the system determines the current label 108 is not in focus, then the process proceeds to step 316. In step 316, the system indicates the current label 108 is out of focus and adds the current label 108 and the second distance of the current label 108 to a list of unprocessed labels 108. In this way, the system improves and enhances a processing efficiency of the device 116 by eliminating the detection and recognition and/or decoding of illegible labels which reduces a processing efficiency of the device 116 and/or system and an efficiency of the detection and identification (e.g., recognition and/or decoding) process of labels 108 present in each image. The process then returns to step 308.

In step 308, the system determines whether each of the one or more labels 108 are assessed. As mentioned above, a portion of the processing steps 300 may repeat until each of the one or more labels 108 are assessed. For example, a portion of the processing steps 300 may repeat until each of the one or more labels 108 are processed in step 314, each of the one or more labels 108 and respective second distances are added to a list of unprocessed labels 108 in step 316, or a portion of the one or more labels 108 are processed in step 314 and the remaining portion of the one or more labels 108 and respective second distances are added to the list of unprocessed labels 108 in step 316. In this way, the system may process each of the one or more labels 108 detected in the current image even if a detected label 108 in the current image is out of focus thereby increasing an image processing efficiency of the system.

If the system determines each of the one or more labels 108 are assessed, then the process proceeds to step 318. In step 318, the system determines and sets, based on the list of unprocessed labels 108, another focus setting of the device 116 for a next image capture. For example, the system may determine and set another focus setting that provides for capturing another image where one or more labels 108 on the list of unprocessed labels 108 are in focus.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A method, comprising:
capturing, by a device utilizing a current focus setting, a current image of an area, the area having one or more labels present therein;
determining a first distance between the device and one or more labels present in the current image based on the current focus setting of the device during capture of the current image;
detecting, utilizing a trained machine learning model, the one or more labels present in the current image, each label having one or more identifiers;
determining whether the one or more labels are assessed;
responsive to determining the one or more labels are not assessed, determining, for a current label among the one or more labels, a second distance between the device and the current label based on a known size of the current label and/or a feature of the current label;
determining whether the current label is in focus based on the first distance, the second distance of the current label, and at least one attribute of the device; and
responsive to determining the current label is in focus, processing the current label.

2. The method of claim 1, wherein the current focus setting is one of a fixed focus setting of the device or an autofocus setting of the device.

3. The method of claim 1, wherein detecting, utilizing the trained machine learning model, the one or more labels present in the current image comprises:
generating a bounding box corresponding to each label; and
determining a pixel size of each label based on a pixel length and/or a pixel height of the bounding box.

4. The method of claim 1, further comprising training a machine learning model to detect the one or more labels based on at least one of historical data including one or more previously detected labels or datasets including images of one or more label types, each label type having a known size.

5. The method of claim 1, wherein
the device is one of a mobile computer, a head-mounted display, a tablet, a smartphone, a camera, or a wearable computing device; and
the at least one attribute of the device is a depth of field.

6. The method of claim 1, wherein processing the current label comprises:
decoding an identifier corresponding to a predetermined symbology and/or barcode data structure; or
utilizing character recognition to recognize an identifier corresponding to a predetermined character string structure.

7. The method of claim 1, further comprising:
responsive to determining the current label is not in focus,
adding the current label and the second distance of the current label to a list of unprocessed labels;
determining whether the one or more labels are assessed;
responsive to determining the one or more labels are assessed, determining and setting, based on the list of unprocessed labels, another focus setting of the device for a next image capture.

8. A device, comprising:
an imaging assembly;
one or more processors; and
a non-transitory computer-readable memory coupled to the one or more processors, the memory storing instructions thereon that, when executed by the one or more processors, cause the one or more processors to:
receive a current image, captured by the imaging assembly utilizing a current focus setting, of an area, the area having one or more labels present therein;
determine a first distance between the device and one or more labels present in the current image based on the current focus setting of the imaging assembly during capture of the current image;
detect, utilizing a trained machine learning model, the one or more labels present in the current image, each label having one or more identifiers;
determine whether the one or more labels are assessed;
responsive to determining the one or more labels are not assessed, determine, for a current label among the one or more labels, a second distance between the device and the current label based on a known size of the current label and/or a feature of the current label;
determine whether the current label is in focus based on the first distance, the
second distance of the current label, and at least one attribute of the imaging assembly; and
responsive to determining the current label is in focus, process the current label.

9. The device of claim 8, wherein the current focus setting is one of a fixed focus setting of the imaging assembly or an autofocus setting of the imaging assembly.

10. The device of claim 8, wherein the instructions, when executed, further cause the one or more processors to detect, utilizing the trained machine learning model, the one or more labels present in the current image by:
generating a bounding box corresponding to each label; and
determining a pixel size of each label based on a pixel length and/or a pixel height of the bounding box.

11. The device of claim 8, wherein the instructions, when executed, further cause the one or more processors to train a machine learning model to detect the one or more labels based on at least one of historical data including one or more previously detected labels or datasets including images of one or more label types, each label type having a known size.

12. The device of claim 8, wherein
the device is one of a mobile computer, a head-mounted display, a tablet, a smartphone, a camera, or a wearable computing device; and
the at least one attribute of the imaging assembly is a depth of field.

13. The device of claim 8, wherein the instructions, when executed, cause the one or more processors to process the current label by:
decoding an identifier corresponding to a predetermined symbology and/or barcode data structure; or
utilizing character recognition to recognize an identifier corresponding to a predetermined character string structure.

14. The device of claim 8, wherein responsive to determining the current label is not in focus, the instructions, when executed, further cause the one or more processors to:
add the current label and the second distance of the current label to a list of unprocessed labels;
determine whether the one or more labels are assessed;
responsive to determining the one or more labels are assessed, determine and set, based on the list of unprocessed labels, another focus setting of the device for a next image capture.

15. A non-transitory computer-readable medium storing instructions thereon that, when executed by one or more processors, cause the one or more processors to:
receive a current image, captured by an imaging assembly utilizing a current focus setting, of area, the area having one or more labels present therein;
determine a first distance between the device and one or more labels present in the current image based on the current focus setting of the imaging assembly during capture of the current image;
detect, utilizing a trained machine learning model, the one or more labels present in the current image, each label having one or more identifiers;
determine whether the one or more labels are assessed;
responsive to determining the one or more labels are not assessed, determine, for a current label among the one or more labels, a second distance between the device and the current label based on a known size of the current label and/or feature of the current label;
determine whether the current label is in focus based on the first distance, the
second distance of the current label, and at least one attribute of the imaging assembly; and
responsive to determining the current label is in focus, process the current label.

16. The non-transitory computer-readable medium of claim 15, wherein the instructions, when executed, further cause the one or more processors to detect, utilizing the trained machine learning model, the one or more labels present in the current image by:
generating a bounding box corresponding to each label; and
determining a pixel size of each label based on a pixel length and/or a pixel height of the bounding box.

17. The non-transitory computer-readable medium of claim 15, wherein the instructions, when executed, further cause the one or more processors to train a machine learning model to detect the one or more labels based on at least one of historical data including one or more previously detected labels or datasets including images of one or more label types, each label type having a known size.

18. The non-transitory computer-readable medium of claim 15, wherein the instructions, when executed, further cause the one or more processors to process the current label by:
decoding an identifier corresponding to a predetermined symbology and/or barcode data structure; or
utilizing character recognition to recognize an identifier corresponding to a predetermined character string structure.

19. The non-transitory computer-readable medium of claim 15, wherein responsive to determining the current label is not in focus, the instructions, when executed, further cause the one or more processors to:
add the current label and the second distance of the current label to a list of unprocessed labels;
determine whether the one or more labels are assessed;
responsive to determining the one or more labels are assessed, determine and set, based on the list of unprocessed labels, another focus setting of the device for a next image capture.
